(19) United States
(12) Patent Application Publication
(10) Pub. No.: US 2023/0406735 A1
(43) Pub. Date: Dec. 21, 2023

(54) PROCESS TO SEPARATE AN AQUEOUS FEED

(71) Applicant: MEZT B.V., The Hague (NL)

(72) Inventors: Adriaan Hendrik LIEFTINCK, Rotterdam (NL); Edward Kenneth SIBEIJN, The Hague (NL); Niels VAN LINDEN, Vlaardingen (NL)

(73) Assignee: MEZT B.V., The Hague (NL)

(21) Appl. No.: 18/029,160

(22) PCT Filed: Oct. 12, 2021
(86) PCT No.: PCT/EP2021/078207

§ 371 Date: Mar. 29, 2023

(30) Foreign Application Priority Data
Oct. 12, 2020 (NL) 2026656
Dec. 31, 2020 (NL) 2027254
Mar. 9, 2021 (NL) 2027725
Jun. 8, 2021 (NL) 2028408

(51) Int. Cl. C02F 1/469; C02F 9/00; C05F 3/06

(52) U.S. Cl. CPC C02F 1/4693; C02F 9/00; C05F 3/06; C02F 2101/16

(57) ABSTRACT

The invention is directed to a process for separating an aqueous feed comprising of dissolved ammonium bicarbonate. The process comprises: a step (a) in which an electrodialysis is performed to obtain a diluate and a concentrate comprising of ammonium bicarbonate and a step (b) in which the total ammonia nitrogen (TAN) as present in the concentrate is separated from the bicarbonate ions as present in the concentrate by means of a bipolar membrane electrodialysis to a total ammonia nitrogen (TAN) alkaline fraction and a bicarbonate acid fraction.

The invention is directed to a process for separating an aqueous feed comprising of ammonium bicarbonate.

Aqueous feeds comprising of ammonium bicarbonate are known in the field of waste water treatment. In such a process a sewage sludge is produced from which the majority of the water is separated. This separated water, also referred to as reject water may contain solids, phosphate, magnesium, calcium, potassium and bicarbonate ions and total ammonia nitrogen (TAN). Phosphate, magnesium and ammonia may form an obstructive struvite scale thereby obstructing pipes, pumps and valves.

In such processes it is found difficult to isolate ammonia from the aqueous solution. Especially when such a solution further comprises any one of solids, bivalent and/or trivalent ions and/or cations or organic acids.

Another aqueous feed comprising dissolved ammonium bicarbonate is obtained when processing animal derived manure. Manure, like animal derived manure, contains nitrogen as organic bound nitrogen, as ammonia, ammonium ions and nitrate ions and other nitrogenous compounds. In an agricultural setting nitrogen compounds are used as fertiliser to grow feedstock for livestock. The livestock in turn produces manure. In an ideal setting the nitrogen produced by the livestock is used as a fertiliser to grow feedstock for said livestock. This would minimise the need to add fresh additional nitrogen based fertiliser. A problem is that manure contains a high amount of ammonia and ammonium ions, referred to as total ammonia nitrogen (TAN). Total ammonia nitrogen may be formed from urea as present in urine as part of the manure. Ammonia can evaporate and negatively influence the air quality. Potassium and phosphorus compounds as present in manure may also cause environmental problems in that they can pollute the soil and surface waters. The presence of high amounts of total ammonia nitrogen therefore do not allow that manure can be simply used as such as a fertiliser. Many technologies are proposed to use the manure as a fertiliser while avoiding that ammonia escapes into the environment.

NL1041567 describes a process where the manure is first homogenised and then separated into a solids fraction and an aqueous fraction. Subsequently the liquid fraction is subjected to a nitrification step, a denitrification step and an electrodialysis step. The liquid effluent as obtained would be of a quality that it could be discharged to surface water.

EP2404662 describes a process where manure is first separated into a solids fraction and an aqueous fraction. Ammonia is separated from the aqueous fraction by contacting with an organic synthetic ion exchanger whereby ammonium ions adsorb to the ion exchanger. The ion exchanger is regenerated by contacting with NaNO₃ whereby ammonium nitrate is obtained. A disadvantage of this process is that it requires the use of additional chemicals. Further the presence of potassium, magnesium and calcium which may be present in manure may cause the ion exchanger to function less optimal.

WO19117710 describes a process wherein the formation of TAN from urea is reduced by an oxidizing biocide treatment. In this treatment peracetic acid is added which reduces the urease activity and therefore the formation of TAN.

US2016271562 and WO2019/151855 describe a process to remove ammonia from an aqueous feed by a bipolar membrane electrodialysis (BPMED) stack. The feedstock may be waste water from fertiliser production or from agricultural sources. US2016271562 describes that the feed is pre-treated by settlement and microfiltration to remove suspended solids before using the feed as feed of the bipolar membrane electrodialysis (BPMED) stack.

A disadvantage of the process of US2016271562 and WO2019/151855 is that the bipolar membrane electrodialysis (BPMED) and especially the bipolar membranes used in the process are prone to fouling. Further the bipolar membranes are complex membranes.

The object of the present invention is to provide a process to isolate the ammonia nitrogen (TAN) from an aqueous feed comprising of dissolved ammonium bicarbonate which does not have the problems of the prior art processes.

This object is achieved by the following process. Process for separating an aqueous feed comprising of dissolved ammonium bicarbonate by
(a) performing an electrodialysis to obtain a diluate and a concentrate comprising of ammonium bicarbonate and
(b) separating the total ammonia nitrogen (TAN) as present in the concentrate from the bicarbonate ions as present in the concentrate by means of a bipolar membrane electrodialysis to a total ammonia nitrogen (TAN) alkaline fraction and a bicarbonate acid fraction.

Applicants have found that with the present process it is possible to isolate the total ammonia nitrogen (TAN) in an efficient manner. By performing step (a) it has been found that less organic compounds and/or particles, which can be present in the aqueous feed, can foul the membranes of the bipolar membrane electrodialysis. Such compounds remain in the aqueous feed to become the diluate. Further it has been found that less of the more complex bipolar membranes are required to achieve the same degree of separation.

The aqueous feed may comprise solids. In the present process substantially all of the solids of the feed end up in the diluate. This is advantageous because step (b) can then be performed in the absence of solids thereby avoiding fouling. Preferably the aqueous feed comprises between 0.1 and 5 wt % solids. Suitably more than 95 wt % of the solids in the aqueous feed have a dynamic diameter of less than 50 μm, preferably less than 5 μm. The solids may be any solids and preferably sludge solids of an anaerobic treating process of municipal or industrial wastewater process or manure solids.

Next to the ammonium bicarbonate bivalent and/or trivalent ions and/or cations may be present in the aqueous feed. Examples of possible bivalent cations are Ca²⁺ and Mg²⁺. An example of a possible trivalent ion is PO₄³⁻. Next to these bivalent and trivalent cations and/or ions also monovalent ions and cations may be present. Examples are K⁺, Na⁺, Cl⁻. The ammonium bicarbonate will be present as HCO₃⁻, CO₃²⁻, NH₃ and NH₄⁺. These compounds are in an equilibrium and their respective presence depends for example on pH and temperature. The total ammonia nitrogen (TAN) is the combined NH₃ and NH₄⁺.

Preferably the aqueous feed comprises phosphate (PO₄³⁻), magnesium as Mg²⁺, calcium as Ca²⁺, potassium as K⁺ and bicarbonate ions (HCO₃⁻) and total ammonia nitrogen (TAN). In step (a) the majority of the phosphate, magnesium and calcium ions remain in the diluate and wherein the majority of the total ammonia and bicarbonate ions and potassium ions end up in the concentrate. This diluate may advantageously be used as a fertiliser as will be described below. Phosphate may be isolated from the diluate by well known processes such as precipitation as struvite. In this description with majority is meant more than 50 wt % and suitably more than 70 wt %.

The aqueous feed may comprise pathogens. An advantage of the present process is that such pathogens will not pass the membranes of step (a) and in any case not the combined membranes of steps (a) and (b). This results in that the total ammonia nitrogen (TAN) alkaline fraction obtained in the process and any further products obtained therefrom can be used as for example a fertiliser in applications where pathogens are to be avoided. Examples of such uses are fertiliser for use in a greenhouse.

The aqueous feed may be a waste water fraction. Such a waste water fraction may be obtained in an anaerobic treating process of municipal or industrial wastewater. Suitably the aqueous feed is reject water obtained in a sludge dewatering process as part of a wastewater treatment plant.

The aqueous feed may also be the liquid fraction of manure. Manure is suitably the mixture of faeces and urine of livestock. The manure may also be manure which has been subjected to an anaerobic digestion process. The majority of the water may be separated from the manure by using well known unit operations such as for example a towerpress, a screwpress, a gravity belt thickener, a centrifuge, a decanter centrifuge, a vibrating sieve, a belt screen press, a micro filter or a disk filter or any combination of such unit operations. The aqueous fraction obtained in such unit operations may have a too high solids content to directly perform step (a). In that case a further separation step may be performed, suitably by means of filtration, like for example making use of a sequence of sieves, self-cleaning rotating filters, bag filters and cartridge filters.

In the electrodialysis (ED) process of step (a) ions are transported via a membrane from the aqueous feed under influence of a positive and negative electrode to a mineral poor aqueous solution to form a so-called concentrate. An electrodialysis (ED) process or electrodialysis (ED) unit does not comprise a bipolar membrane. Solids cannot pass such membranes of the electrodialysis (ED) process or electrodialysis (ED) unit and remain in the aqueous solution as fed to process to become a so-called diluate. The advantage of performing an electrodialysis (ED) in step (a) is that almost no solids or other compounds which may foul the bipolar membrane electrodialysis unit of step (b) are present in the concentrate. This will simplify the process for performing step (b). Any fouling of the membranes of the electrodialysis process step by solids can be easily removed by means of changing the polarity of the electrodes of the electrodialysis process step. Such a simple cleaning is not possible in the bipolar membrane electrodialysis of step (b).

The electrodialysis is performed by applying a polarity between two electrodes. It has been found that it is advantageous to periodically reverse the polarity of the electrodes. By also adapting the flows it is possible to achieve the required separation of the aqueous feed in such a mode where the polarity is reversed. Such a reversing polarity is also known as an electrodialysis reversal (EDR) process. In such a process an electrodialysis reversal (EDR) unit may be used. The optimal period in which the electrodialysis is performed at one polarity before reversing the polarity may depend on the type and amount of fouling components present in the aqueous feed and can easily be determined.

The diluate comprising of the solids and the majority of the bivalent and/or trivalent ions and/or cations can now be processed in the absence of TAN or in any event substantial quantities of TAN. This allows one to use the resulting diluate which is rich in phosphate and optionally magnesium and calcium ions as a fertiliser with a minimum of ammonia emissions into the environment.

In step (b) the concentrate is separating into a total ammonia nitrogen (TAN) alkaline fraction and a bicarbonate acid fraction. Such a separation may be performed in a so-called bipolar membrane electrodialysis system of the two chamber type of the acidic type or of the three-chamber type. Bipolar membrane electrodialysis is also referred to as BPMED in this description. For a bipolar membrane electrodialysis system of the two chamber type as provided with only bipolar membranes (BPM) and anion exchange membranes (AEM) bicarbonate will predominantly pass the anion exchange membranes (AEM) to become the bicarbonate acid fraction. The starting concentrate will then become the total ammonia nitrogen (TAN) alkaline fraction.

For a bipolar membrane electrodialysis system of the two chamber type of the alkalic type as provided with only bipolar membranes (BPM) and cation exchange membranes (CEM) ammonium ions will predominantly pass the cation exchange membranes (CEM) to become the total ammonia nitrogen (TAN) alkaline fraction. The starting concentrate will then become the bicarbonate acid fraction.

Step (b) may also be performed in a so-called bipolar membrane electrodialysis system of the three chamber type with bipolar membranes (BPM), an anion exchange membranes (AEM) and a cation exchange membranes (CEM). In such a system bicarbonate will predominantly pass the anion exchange membranes (AEM) to become the bicarbonate acid fraction and ammonium ions will predominantly pass the cation exchange membranes (CEM) to become the total ammonia nitrogen (TAN) alkaline fraction. The remaining concentrate which is poorer in both bicarbonate and ammonium ions as compared to the starting concentrate is referred to as a third remaining fraction. Suitably this third remaining fraction is suitably recycled to step (a) where it picks up dissolved ammonium bicarbonate to become the concentrate stream. A purge may be present in this recycling stream to avoid that minerals will accumulate. In a continuous process a purge stream may be used to influence the levels of these minerals.

The bipolar membrane electrodialysis system of the two chamber type or the three chamber type for performing the above separation may comprise of a stack of between 1 and 200 cell pairs present between an anode and a cathode. For the acidic two chamber type system each cell pair comprises a bipolar membrane (BPM) and an anion exchange membrane (AEM) and wherein the distance between bipolar membrane (BPM) and the anion exchange membrane (AEM) is between 0.1 and 10 mm. For the two chamber type system of the alkalic type each cell pair comprises a bipolar membrane (BPM) and a cation exchange membrane (CEM) and wherein the distance between bipolar membrane (BPM) and the cation exchange membrane (CEM) is between 0.1 and 10 mm.

The bipolar membrane electrodialysis system of the three chamber type may comprise of a stack of between 1 and 200 cell triplets as present between an anode and a cathode. Each cell triplet comprises a bipolar membrane (BPM), an anion exchange membrane (AEM) and a cation exchange membrane (CEM) and wherein a spacer is present between the anion exchange membrane (AEM) and the cation exchange membrane (CEM) such that the distance between the anion exchange membrane (AEM) and the cation exchange membrane (CEM) is between 0.1 and 10 mm.

At both ends of the stack of the above two and three chamber systems a cathode and an anode is present. Typically, both the anode and cathode face the same membrane which may be an anion exchange membrane (AEM), a cation exchange membrane (CEM) or a bipolar membrane (BPM).

In a three chamber system ammonium ions as present in the concentrate are transported via the cationic exchange membrane (CEM) under influence of an applied potential between anode and cathode to an aqueous solution to become the total ammonia nitrogen (TAN) alkaline fraction rich in total ammonia nitrogen (TAN). The bicarbonate ions as present in the concentrate are transported via an anionic exchange membrane (AEM) under influence of the applied potential to an aqueous solution to become the bicarbonate acid fraction. The remaining aqueous fraction from which ammonium ions and carbonate ions are removed is the earlier referred to third remaining fraction. To the bicarbonate acid fraction protons (as H⁺) are supplied from the bipolar membrane (BPM) and to the total ammonia nitrogen (TAN) alkaline fraction hydroxyl ions (OH⁻) are supplied from a next bipolar membrane (BPM) to balance the valence of the separation process.

A two chamber type is advantageous because it is more energy efficient compared to a three chamber type and a higher recovery of TAN to the alkaline fraction is possible.

Step (b) may be performed as a batch process, semi-batch process or continuous process. To the spaces between the membranes of the bipolar membrane electrodialysis system which receive the ammonium ions, and/or the carbonate ions fresh water and/or recycle streams may be supplied. The recycle streams for a three chamber system may be the total ammonia nitrogen (TAN) alkaline fraction and/or the bicarbonate acid fraction, preferably after separating part of the ammonia and carbon dioxide respectively. The resulting aqueous alkaline fraction is recycled to the spaces which receive ammonium ions and the resulting aqueous fraction is recycled to the spaces which receive the carbonate ions. Further details for performing step (b) may be found in WO2019/151855.

From the bicarbonate acid fraction carbon dioxide may be separated. This may be to obtain an aqueous fraction poor in bicarbonate. Carbon dioxide will in most cases separate easily from the bicarbonate acid fraction. Separation may be enhanced by means of a vacuum membrane separation. The carbon dioxide will be biobased and may therefore have a higher value for end users. Such end users or uses may be greenhouse crop growers or soda drinks. The remaining aqueous fraction poor in bicarbonate is suitably recycled to step (a) where it picks up dissolved ammonium bicarbonate to become the concentrate stream.

The obtained total ammonia nitrogen (TAN) alkaline fraction and/or the bicarbonate acid fraction may be used to clean the electrodialysis membranes and the bipolar membrane electrodialysis membranes such to avoid fouling by growth of biologically active organisms. For example membranes which are under normal operation operated in an alkaline environment may be subject to fouling by growth of biologically active organisms which favour such alkaline environments. By periodically flushing the membranes with an acidic aqueous solution such fouling may be removed and/or the organisms may be killed.

The alkaline fraction rich in total ammonia nitrogen (TAN) as obtained in step (b) may find applications as feedstock in for example non-agricultural processes such as a nutrient for microbial protein production, absorption fluid for CO₂ absorption processes and for increasing the pH in an aqueous solution. Suitably this alkaline fraction is used to prepare a fertiliser, preferably on site where the process is performed. This may be by adding sulfuric acid and/or nitric acid to the alkaline fraction to obtain an aqueous solution of ammonium sulphate or ammonium nitrate and optionally potassium. Such an aqueous solution of ammonium sulphate or ammonium nitrate may also be obtained by scrubbing a gas comprising of ammonia as obtained by the process described below with an aqueous solution of sulfuric acid or nitric acid. The obtained aqueous solution of ammonium sulphate or ammonium nitrate may find use as a potassium poor fertiliser for example by spraying.

From the total ammonia nitrogen (TAN) alkaline fraction ammonia may be separated. This for example to obtain a more concentrated ammonia fraction and/or to separate ammonia from potassium which may be part of total ammonia nitrogen (TAN) alkaline fraction. The potassium will then remain in the aqueous fraction from which total ammonia nitrogen (TAN) is removed. This potassium aqueous fraction may be used as a fertiliser or as part of a fertiliser.

Ammonia may be separated from the total ammonia nitrogen (TAN) alkaline fraction by various methods known to the skilled person, such as vacuum stripping, steam stripping and membrane degassing. Suitably the ammonia is separated by means of a vacuum membrane separation wherein a mixture of ammonia and water vapour is obtained. The thus isolated ammonia may be combusted with air to nitrogen gas and water. A disadvantage is that nitrous oxides may form as a by-product. Suitably the mixture of ammonia and water vapour is used as a feedstock for a fuel cell to generate electricity as for example described in WO2019/151855.

Another suitably process to separate ammonia from the alkaline fraction is by directly contacting the alkaline fraction with a plasma activated aqueous solution comprising nitrate ions to obtain an ammonium nitrate aqueous solution. Preferably the ammonia as separated from the alkaline fraction, by for example the above described vacuum membrane separation and the optional enrichment step, is suitably contacted with a plasma activated aqueous solution comprising nitrate ions to obtain an ammonium nitrate aqueous solution. This would avoid that the resulting ammonium nitrate aqueous solution would contain potassium which may be present in the alkaline fraction. The plasma activated aqueous solution may be obtained by the method and system as described in for example U.S. Pat. No. 10,669,169.

The gaseous mixture of ammonia and water vapour obtained in the vacuum membrane separation may be enriched in ammonia in an enrichment step by condensing part of the water under vacuum pressure conditions. The resulting gaseous mixture enriched in ammonia may then be contacted with nitric acid or sulfuric acid to prepare ammonium nitrate or ammonium sulphate respectively. The resulting gaseous ammonia may also be condensed by compression of the gas and cooling. The condensed water which may contain some ammonia may be combined with the potassium aqueous fraction as described above before being used as for example a fertiliser.

Suitably ammonia is separated in a next step (c) from the total ammonia nitrogen (TAN) alkaline fraction by means of a membrane stripping process using an acidic aqueous solution of preferably sulfuric acid or nitric acid as a stripping medium thereby obtaining an aqueous solution of an ammonium salt, preferably ammonium sulphate or ammonium nitrate respectively. The membrane is suitably a hydrophobic membrane. An example of such a process is the Ammonia Membrane Stripping process of Blue-tec BV, The Netherlands.

The remaining aqueous fraction from which total ammonia nitrogen (TAN) is removed is suitably recycled to step (a) where it picks up dissolved ammonium bicarbonate to become the concentrate stream. A purge is preferably present in this circulating aqueous stream to avoid a build-up of non-separated ions and cations, such as especially potassium cations.

The obtained aqueous solution of ammonium sulphate or ammonium nitrate may find use as a potassium poor fertiliser.

The separated carbon dioxide may be contacted with the potassium aqueous fraction to obtain a potassium bicarbonate aqueous fraction. Potassium bicarbonate may be used for neutralizing acidic soil or as a fungicide against powdery mildew and apple scab.

The invention is thus also directed to a process to prepare ammonium sulphate from reject water comprising solids, phosphate, magnesium, calcium, potassium and bicarbonate ions and total ammonia nitrogen (TAN) by
(aa) performing an electrodialysis resulting in that the majority of the phosphate, magnesium and calcium ions remain in a diluate and wherein the majority of the total ammonia and bicarbonate ions and potassium ions end up in a concentrate,
(bb) separating the total ammonia nitrogen (TAN) as present in the concentrate from the bicarbonate ions as present in the concentrate by means of a bipolar membrane electrodialysis into a total ammonia nitrogen (TAN) alkaline fraction and a bicarbonate acid fraction, and
(cc) separating ammonia from the total ammonia nitrogen (TAN) alkaline fraction by means of a membrane stripping process using an aqueous solution of sulfuric acid or nitric acid as a stripping medium thereby obtaining an aqueous solution of ammonium sulphate or ammonium nitrate.

In another embodiment the invention is directed to a process to separate manure comprising of an aqueous suspension of solid particles comprising of organic bound nitrogen and total ammonia nitrogen (TAN) by performing the following steps
(i) separating the majority of the solids from the aqueous suspension such to obtain a first wet solids fraction rich in organic bound nitrogen and a first aqueous fraction rich in total ammonia nitrogen (TAN) and solid particles,
(ii) separating the majority of the solid particles from the first aqueous fraction to obtain a second aqueous fraction poor in solids and a second solids fraction, and
(iii) separating the second aqueous fraction comprising of dissolved ammonium bicarbonate by the process according to this invention.

Applicants have found that with the above process to separate manure the total ammonia nitrogen (TAN) is effectively separated from the manure solid particles. Further the process provides solid fractions and different aqueous fractions having different compositions in terms of total ammonia nitrogen, potassium and phosphorus compounds. This enables one to use these fractions in admixture or separately as a fertiliser. By being able to prepare such mixture based on these different obtained fractions in varying compositions a tailor made bio fertiliser may be prepared which complies with the seasonal nitrogen, potassium and phosphorus demand at that time, suited for a particular grass or crop and/or suited for a particular soil type. This biobased fertiliser which may be prepared by the farmer on site or at an offsite manure processing facility can replace industrially produced fertilizer. This avoids or limits the use of industrially produced fertilizer and thereby reducing costs and CO₂ footprint, both as a result from the manufacturing process as the transportation of such an industrially produced fertilizer. Further there is no or less need to apply complex ground injection techniques to avoid ammonia emissions when using the fractions which are poor in total ammonia nitrogen (TAN). A further advantage is that the obtained aqueous alkaline fraction rich in total ammonia nitrogen (TAN) may find use in many applications like non-agricultural applications or alternatively be used locally as here described.

The manure as used in step (i) may originate from faeces and urine of livestock. When the manure is stored the urea as present in urine will be converted to total ammonia nitrogen (TAN). The total ammonia nitrogen (TAN) is the combined NH₃ and NH₄⁺. These two compounds are in an equilibrium and their respective presence depends for example on pH and temperature. The ionic NH₄⁺ is mainly present in manure as an ammonium bicarbonate salt. The manure comprises of organic bound nitrogen and total ammonia nitrogen (TAN). In addition the manure may comprise of phosphate, potassium, sodium, chloride, calcium, magnesium and volatile fatty acids also referred to as short chain fatty acids. These acids are derived from intestinal microbial fermentation of indigestible foods. Such acids will end up for the most part in the bicarbonate acidic fraction of step (b). In step (b) and especially when performed in a three chamber system an acidic fraction comprising bicarbonate ions and volatile fatty acids is obtained. This fraction may be separated into a gaseous fraction comprising carbon dioxide and an aqueous fraction comprising of volatile fatty acids in for example a vacuum membrane separator as described above. This aqueous fraction comprising the volatile fatty acids may be combined with the gaseous ammonia in a scrubber for use as a fertiliser and/or it may be combined with the potassium rich aqueous solution from which total ammonia nitrogen (TAN) is removed as described above for use as a fertiliser.

The manure may also be manure which has been subjected to an anaerobic digestion process before being treated in step (i). This anaerobic digestion process converts the majority of organic bound nitrogen into total ammonia nitrogen (TAN).

In order to minimize the formation of TAN or evaporation of ammonia it is preferred to perform step (i) with manure which is less than 2 days, preferably one day old, i.e. after having been produced by the livestock or with the digestate obtained in the anaerobic digestion process which has been obtained within 2 days preferably within one day.

Step (i) may be performed by any process which can separate the manure in a fraction enriched in solids and a fraction enriched in water. Preferably a separation process which can remove the majority of the water as present in the manure. Suitably a first wet solids fraction is obtained in step (i) having a solid content of between 5 and 40 wt % and the remaining being substantially an aqueous water fraction. Suitably step (i) is performed such 30 that at least 60%, preferably at least 70% of the solids as present in the aqueous suspension is comprised in the first fertiliser. This results in that the majority of the organic bound carbon, organic bound phosphorus and organic bound nitrogen as present in the manure is found in the first wet solids fraction while the majority of the formed TAN is found in the first aqueous fraction. The organic bound carbon as part of the first fertiliser is advantageous because when used less nitrogen, potassium and phosphate will end up in ground water and/or in canals and lakes. Further it provides a means to reuse the carbon as present in the manure. Such processes are well known in manure processing and examples of suitable process units for performing step (i) are a towerpress, a screwpress, a gravity belt thickener, a centrifuge or a decanter centrifuge.

Step (i) may also be performed more upstream to the livestock where faeces and urine are separated by using special floors supporting the livestock as described in WO19156551 and NL2020449. Such a special floor suitably comprises a plurality of openings which are configured to allow the wet fraction of the excretory products to pass through and to retain the solid fraction. The expression wet fraction is understood to mean mainly the urine and the expression solid fraction to mean mainly faeces. A complete separation of urine and faeces is impossible and in practice some lumps of faeces will pass through the openings and some urine will remain behind on the floor surface. By means of such a floor, the urine is separated from the faeces situated on the floor almost immediately after excretion by the livestock animal. In this separation the separated faeces is the first wet solids fraction rich in organic bound nitrogen and the separated urine is the first aqueous fraction rich in total ammonia nitrogen (TAN) and solid particles. The separated faeces may be further enriched in solids in an apparatus as described above for step (a). The faeces contain enzymes which are able to convert the urea in the urine quickly into ammonia which can readily evaporate. By quickly separating the urine, this reaction hardly takes place. The faeces may be recovered from the floor by well known means such as a manure removal device, such as a manure slide, for removing the solid fraction of the excretory products.

In step (ii) a large part of the solids which remain in the first aqueous fraction is separated. Such a separation is preferably performed by means of filtration thereby obtaining a filtrate and a retentate. The filtration is suitably performed such that more than 95 wt % of the solids in the second aqueous fraction have a dynamic diameter of less than 50 μm, preferably less than 20 μm and even more preferably less than 5 μm. The filtration suitably also results in a second aqueous fraction having a solid content of between 0.1 and 5 wt %. Such a separation is not complex and may be performed by for example a sequence of sieves, self-cleaning rotating filters, bag filters and cartridge filters. The solid particles as separated as the retentate may be used as a second fertiliser as such. Suitably this second fertiliser is combined with the first fertiliser as obtained in step (i). Step (i) and (ii) may be performed in one apparatus.

The diluate as obtained in the electrodialysis (ED) process of the process to separate manure is suitably stored in a storage vessel. Suitably part of the diluate is used to enhance the transport of fresh manure as produced by the livestock to a short stay storage vessel. Enhancing the transport may be by dilution and/or flushing of the manure. The manure will become more fluid and will be transported faster via for example sleeves in stable floors, gutters and the like. Preferably the manure as collected in this short stay storage vessel is subjected to step (b) within 48 hours, preferably within 24 hours. In a more continuously operated process the residence time of the manure will be less than 48 hours and 24 hours respectively. It has been found that the rapid collection of manure with the assistance of part of the diluate and the quick further processing in step (ii) a significant reduction in formation and emissions of ammonia and methane is achieved next to the high ammonia recovery according to this invention. This process does not only require less energy than the prior art processes, it also requires less chemicals. For this reason the invention is also directed to the following process.

Process to treat fresh manure in a livestock stable wherein
(I) fresh manure as produced by the livestock is collected into a first storage vessel by transport from the livestock to the first storage vessel,
(II) wherein within 48 hours, preferably within 24 hours, the fresh manure is discharged from the first storage vessel and separated in one or more steps into a wet solids fraction and an aqueous fraction rich in total ammonia nitrogen (TAN),
(III) separating the aqueous fraction by means of electrodialysis to obtain a concentrate rich in total ammonia nitrogen (TAN) and a diluate, and
(IV) storing the majority of the diluate in a second storage vessel and using a part of the diluate to enhance the transport of the fresh manure to the first storage vessel in step (I).

In the process to separate manure several products or fractions are obtained which may find use as a fertiliser or as starting compound for a process to prepare a fertiliser.

A first fertiliser is the first wet solids fraction rich in organic bound nitrogen obtained in step (i).

A second fertiliser is the second solids fraction obtained in step (ii).

A third fertiliser is the diluate which is enriched in phosphate, magnesium and calcium ions relative to the total ammonia nitrogen (TAN) obtained in the electrodialysis step (a).

A fourth fertiliser is the alkaline fraction obtained in step (b) rich in total ammonia nitrogen (TAN) and potassium.

A fifth fertiliser is the third remaining fraction obtained in a bipolar membrane electrodialysis system of the three chamber type or a purge of this fraction when this fraction is recycled to the electrodialysis.

A sixth fertiliser is an aqueous fraction enriched in total ammonia nitrogen (TAN) obtainable by vacuum membrane separation described above.

A seventh fertiliser is a potassium aqueous fraction obtainable as the remaining fraction in a vacuum membrane separation described above.

A eighth fertiliser is an ammonium nitrate or ammonium sulphate aqueous fraction obtainable by the processes described above.

A ninth fertiliser is a potassium bicarbonate aqueous fraction obtainable by contacting carbon dioxide with the afore mentioned potassium aqueous fraction.

A tenth fertiliser is an aqueous fraction comprising the dissolved salt of ammonium and volatile fatty acids as described above.

An eleventh fertiliser is an aqueous fraction comprising the dissolved salt of potassium and volatile fatty acids as described above.

The ammonia as separated from the alkaline fraction including the optional ammonia enrichment step, as described above, may suitably be contacted with an activated carbon or preferably with a biochar to obtain an ammonium loaded activated carbon or preferably an ammonium loaded biochar. The loaded activated carbon or preferably an ammonium loaded biochar is suitably used as a fertiliser. The ammonia may be separated as part of an aqueous solution as for example described in CN109908867. The ammonia is preferably contacted with the activated carbon or biochar as gaseous ammonia. Preferably the activated carbon or biochar is activated by first contacting the activated carbon or biochar with a strong mineral acid, such as nitric acid, sulfuric acid or phosphoric acid as for example described in US2008047313. Alternatively the activated carbon or biochar can also be activated using the bicarbonate acid fraction or the aqueous fraction comprising the volatile fatty acids as obtained from the bicarbonate acid fraction as described above.

Preferably a biochar is used as obtained in a pyrolysis process of a biomass feedstock. The biomass may be any biomass source such as virgin biomass and waste biomass. Virgin biomass includes all naturally occurring terrestrial plants such as trees, i.e. wood, bushes and grass. Waste biomass is produced as a low value by-product of various industrial sectors such as the agricultural and forestry sector. Examples of agriculture waste biomass are corn stover, sugarcane bagasse, beet pulp, rice straw, rice hulls, barley straw, corn cobs, wheat straw, canola straw, rice straw, oat straw, oat hulls and corn fibre. A specific example is palm oil waste such as oil palm fronds (OPF), roots and trunks and the by-products obtained at the palm oil mill, such as for example empty fruit bunches (EFB), fruit fibers, kernel shells, palm oil mill effluent and palm kernel cake. Examples of forestry waste biomass are saw mill and paper mill discards. For urban areas, the best potential plant biomass feedstock includes yard waste (e.g., grass clippings, leaves, tree clippings, and brush) and vegetable processing waste. Waste biomass may also be Specified Recovered Fuel (SRF) comprising lignocellulose. Examples of such pyrolysis processes to make biochar from such biomass feedstocks are described in US2013213101 and CN107892628.

A most preferred biomass is the first wet solids fraction optionally in admixture with the second wet solids fraction as obtained in a process according to this invention. The first wet solids fraction optionally in admixture with the second wet solids fraction may for example be used to prepare in a pyrolysis process to obtain a biochar on site where the manure is being produced by livestock. Suitably the first wet solids fraction optionally in admixture with the second wet solids fraction are collected from more than one of such sites and processed by pyrolysis centrally in a larger scale process to obtain the biochar. This biochar may then be distributed to those farmers wishing to use the biochar as here described. By using biochar prepared based on the first wet solids fraction optionally in admixture with the second wet solids fraction to prepare a fertiliser as here described even further improves the reuse of the livestock manure in an agricultural closed loop. Further the fertiliser will release its minerals as a slow release fertiliser. This avoids that ammonium, phosphate and potassium are instantaneously released when the fertiliser is used. Thus avoiding pollution of surface water, nature reserves and the like.

Pyrolysis of the first wet solids fraction optionally in admixture with the second wet solids fraction to biochar is a well known process and for example described in CN108947651, CN106495942 and WO20201636.

The first wet solids fraction optionally in admixture with the second wet solids fraction may for example be gasified to obtain a synthesis gas and a biochar. An example of such a process is the Mavitec Gasification System as obtainable from Mavitec, Heerhugowaard, The Netherlands.

Suitably the potassium aqueous fraction obtainable as the remaining fraction in a vacuum membrane separation as described above is contacted with an activated carbon or contacted with a biochar to obtain a potassium loaded activated carbon or a potassium loaded biochar. The biochar may be as described above and the potassium loaded activated carbon or potassium loaded biochar may be used a fertiliser, preferably as a slow release fertiliser.

The above described potassium bicarbonate aqueous fraction may be contacted with an activated carbon or contacted with a biochar to obtain a potassium bicarbonate loaded activated carbon or a potassium bicarbonate loaded biochar. The preferred biochar may be as described above.

The process to separate manure according to this invention is preferably performed on site where the manure is being produced by livestock, especially cows or pigs, and where the first, second, third, fourth, fifth, sixth, seventh, eighth, ninth fertiliser, tenth and/or eleventh or any other fertiliser as described in this description find application as a fertiliser in the process of growing plants. These fertilisers may also be combined with fresh manure. Suitably these plants are the food for said livestock making the process circular. Suitably the process to separate manure is performed in one location where the manure is produced by livestock and that the different fertilisers are stored at that same location for use as a fertiliser at that same location thereby creating a closed loop for the majority of the nitrogen, phosphor and potassium. As is clear from this description the different fertilisers differ in composition and especially differ in the relative contents of nitrogen, phosphor and potassium. By using these fractions in admixture or separately as a fertiliser it is possible to tailor make a bio fertiliser which complies with the seasonal nitrogen, potassium and phosphorus demand at that time, suited for a particular grass or crop and/or suited for a particular soil type thereby preferably taking into account the maximum agricultural nutrient application levels as required by local law .

Preferably the content of TAN, organic bound nitrogen, phosphate and potassium is measured in as many of the different fractions or fertilisers described above as possible. Unknown contents and mass flows are suitably estimated based on mass balance calculations. This allows for an automated administration of on-site use of these different manure components and of the export of these manure components. In an even more preferred embodiment this information is directly shared with the local authorities as may be required by local law.

Further it is preferred that the equipment as used in the process to separate manure in steps (i)-(iii) is remotely monitored. This may enable a number of significant opportunities: 1) remote monitoring, support and maintenance by vendors of the equipment ensuring operating integrity, 2) on-line book keeping of agricultural nutrient application as required by (Dutch) law (replacing costly, slow and error prone manual administration, transportation and laboratory analysis processes) and 3) data exchange within a central machine learning infrastructure connecting a large network of individual processing sites sharing process conditions, like for example temperature, fluids flow, nutrient extraction rates and energy usage, and relevant external conditions, like for example climate, nutrient stock levels and market pricing, that combined with each other may deliver new technical, economic and ecological insights that benefit the local users of the invented process and society.

The livestock food to be locally cultivated may be for example gran and corn. This local re-use of the manure is advantageous because it avoids that manure has to be transported to a central processing unit and that any obtained fertilisers from this transported manure have to be transported back to be used as fertiliser. By local use is also understood a situation where neighbouring farmers may provide each other first to ninth fertilisers. This may be advantageous when for example one farmer has relatively more land to grow livestock feed, when one farmer has a process to prepare aqueous solutions of ammonium nitrate or ammonium sulphate and the other farmer has not or when a unit operation at one farmer is out of operation.

The process according to the invention may be performed centrally wherein manure is transported from the farmers to a central processing facility where the process to separate manure and optional further downstream processes as here described are performed. The advantages may still be large even though one will have the disadvantage of having to transport the manure and the obtained fertilisers.

The invention is also directed to the following process. Process to separate an aqueous fraction comprising solid manure particles and total ammonia nitrogen (TAN), preferably also potassium and phosphate, into at least an aqueous alkaline fraction rich in total ammonia nitrogen (TAN) and optional potassium, an aqueous acidic fraction and a solid particle comprising aqueous fraction poor in total ammonia nitrogen (TAN) and rich in optional phosphate by means of bipolar membrane electrodialysis, wherein the aqueous fraction comprising solid manure particles has a solid content of between 0.1 and 5 wt %.

Preferably more than 95 wt % of the solid particles as comprised in the aqueous fraction have a dynamic diameter of less than 50 μm, preferably less than 20 μm and even more preferably less than 5 μm.

The invention is also directed to a process to separate part of the phosphate from the diluate as obtained in the earlier referred to electrodialysis (ED). This diluate fraction will be of a large volume mainly consisting of water. Because of the high phosphate content it cannot simply be distributed over the land. Applicant now found that by contacting the diluate with an activated carbon and/or with a biochar all or part of the bivalent or trivalent ions, like phosphate or cations, like calcium or magnesium are absorbed onto the activated carbon and/or onto the biochar. The biochar may be as described above. The resulting cleaned aqueous fraction will have a lower phosphate content and can be more easily used or disposed of. The loaded activated carbon or biochar may be used as a fertiliser as described above.

In view of the above the invention is also directed to a manure separation process configuration comprising of
a first separator in which a manure comprising of an aqueous suspension of solid particles comprising of organic bound nitrogen and total ammonia nitrogen (TAN) is separated into a first wet solids fraction rich in organic bound nitrogen and a first aqueous fraction rich in total ammonia nitrogen (TAN) and solid particles,
a second separator for separating the majority of the solid particles from the first aqueous fraction by means of filtration to obtain a filtrate and a second solids fraction,
an electrodialysis unit suited to obtain a diluate and a concentrate as the second aqueous fraction and
an absorption unit comprising activated carbon or a biochar for contacting the diluate with the activated carbon or with biochar.

The concentrate of the electrodialysis unit does not necessarily have to be further treated in the bipolar membrane electrodialysis unit as in the process described above. It may alternatively be contacted with activated carbon or a biochar to obtain a loaded activated carbon or biochar comprising ammonium and potassium and a filtrate. Part of the filtrate is suitably recycled to the electrodialysis unit and part of the filtrate may be purged.

Thus the invention is also directed to a manure separation process configuration comprising of
a first separator in which a manure comprising of an aqueous suspension of solid particles comprising of organic bound nitrogen and total ammonia nitrogen (TAN) is separated into a first wet solids fraction rich in organic bound nitrogen and a first aqueous fraction rich in total ammonia nitrogen (TAN) and solid particles,
a second separator for separating the majority of the solid particles from the first aqueous fraction by means of filtration to obtain a filtrate and a second solids fraction,
an electrodialysis unit suited to obtain a diluate and a concentrate as the second aqueous fraction and
an absorption unit comprising activated carbon or biochar for contacting the concentrate with the activated carbon or biochar.

A manure separation process system having an absorption unit for the diluate and an absorption unit for the concentrate is also possible. Thus the invention is also directed to the following process.

Process to separate manure comprising of an aqueous suspension of solid particles comprising of phosphate, potassium, organic bound nitrogen and total ammonia nitrogen (TAN) by performing the following steps
(A) separating the majority of the solids from the aqueous suspension such to obtain a first wet solids fraction rich in organic bound nitrogen and a first aqueous fraction comprising phosphate, potassium and total ammonia nitrogen (TAN) and solid particles,
(B) separating the majority of the solid particles from the first aqueous fraction to obtain a second aqueous fraction poor in solids and a second solids fraction, and
(C) separating the second aqueous fraction by means of an electrodialysis to obtain a diluate comprising of substantially all of the solids and phosphate and a concentrate comprising the majority of the ammonium bicarbonate and potassium, and
(D) contacting the diluate with activated carbon or biochar to obtain a loaded activated carbon or biochar comprising phosphate and/or contacting the concentrate with activated carbon or a biochar to obtain a loaded activated carbon or biochar comprising ammonium and potassium and a filtrate.

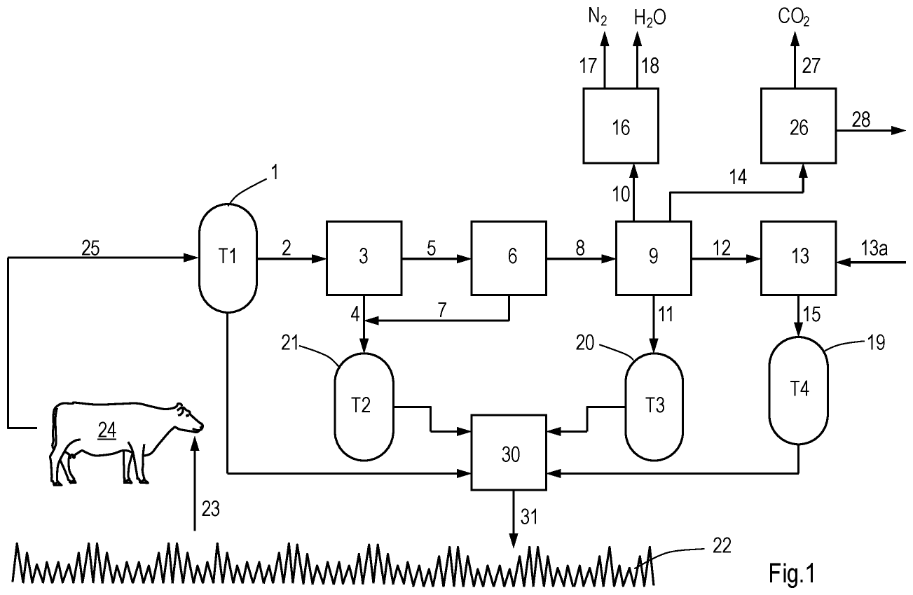

The invention will be illustrated by FIGS. 1-6.

FIG. 1 shows a manure recycle process configuration or system suited to perform the process according to this invention. The invention is also directed to such a manure recycle process system comprising of
a first separator (3) in which a manure (2) comprising of an aqueous suspension of solid particles comprising of organic bound nitrogen and total ammonia nitrogen (TAN) is separated into a first wet solids fraction (4) rich in organic bound nitrogen as a first fertiliser and a first aqueous fraction (5) rich in total ammonia nitrogen (TAN) and solid particles,
a second separator (6) suited to separate the majority of the solid particles from the first aqueous fraction (5) by means of filtration to obtain a second aqueous fraction poor in solids (8) and a second solids fraction (7) as a second fertiliser,
a combined electrodialysis unit and bipolar membrane electrodialysis unit (9) separates the second aqueous fraction poor in solids (8) into a diluate (11) as a fertiliser, a total ammonia nitrogen (TAN) alkaline fraction (12) and a bicarbonate acid fraction (14).

The combined electrodialysis unit and bipolar membrane electrodialysis unit (9) may also comprise a membrane vacuum separator to obtain a gaseous ammonia/water mixture (10) from part of the alkaline fraction (12). This gaseous ammonia/water mixture (10) may be used to generate electricity in fuel cell (16).

The manure recycle process configuration may further comprise an ammonium salt processing unit (13) in which all or part of the alkaline fraction (12) rich in total ammonia nitrogen (TAN) is contacted with sulfuric acid and/or nitric acid (13a) to obtain an aqueous solution (15) of ammonium sulphate or ammonium nitrate as a eighth fertiliser.

The manure recycle process system may further comprise a carbon dioxide reclaiming unit (26) where carbon dioxide (27) is reclaimed from the bicarbonate acidic fraction (14) to obtain a less acidic aqueous fraction (28).

The manure recycle process system may further comprise of a holding vessel T1 (1) for manure, a holding vessel T2 (21) for the first fertiliser and optionally combined with the second fertiliser, a holding tank T3 (20) for the third fertiliser and a holding tank T4 (19) for the eighth fertiliser (15). From these holding tanks T1-T4 an optimal fertiliser (31) may be blended using a blending unit (30). The blended fertiliser (31) may be used as a fertiliser for growing grass (22). This grass (23) is subsequently consumed by cows (24) generating manure (25) which is stored in holding vessel T1 (1) thereby closing the cycle.

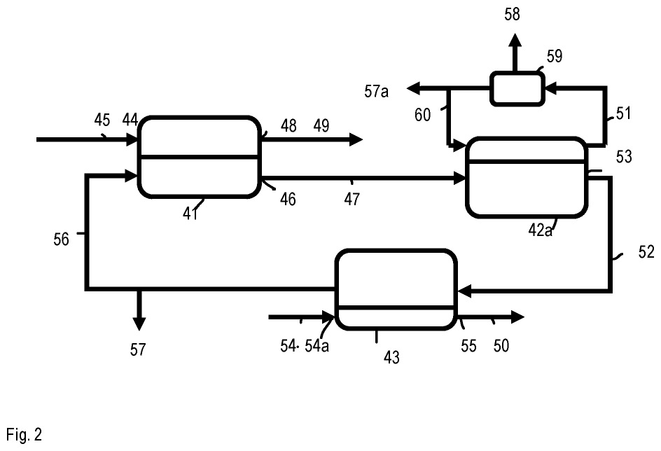

FIG. 2 shows the combined electrodialysis unit and bipolar membrane electrodialysis unit (9) and ammonium salt processing unit (13) of FIG. 1 in more detail. The figure shows a process scheme consisting of an electrodialysis unit (41), a bipolar membrane electrodialysis unit (42) and a membrane stripping unit (43). The electrodialysis unit (41) has an inlet (44) for reject water (45), an outlet (46) for a concentrate (47) and an outlet (48) for a diluate (49). In diluate (49) almost all of the solids and most of the phosphate ions, magnesium cations and calcium cations will be present. The majority of the total ammonia nitrogen (TAN) and bicarbonate ions and potassium ions end up in a concentrate (47). The outlet (46) for a concentrate (47) is fluidly connected to a bipolar membrane electrodialysis unit (42a). The bipolar membrane electrodialysis unit (42a) of

FIG. 2 is a unit of the two chamber type wherein each cell pair comprises a bipolar membrane (BPM) and an anion exchange membrane (AEM). In such a unit (42a) bicarbonate ions will predominantly pass the anion exchange membranes (AEM) to become a bicarbonate acid fraction (51). The starting concentrate (47) will the become the total ammonia nitrogen (TAN) alkaline fraction (52). The majority of the ammonium and potassium cations as present in the concentrate (47) thus do not pass a membrane and remain in the aqueous fraction (52). An outlet (53) for the total ammonia nitrogen (TAN) alkaline fraction (52) is fluidly connected to the membrane stripping unit (43). To membrane stripping unit (43) an aqueous acid feed (54) is fed via inlet (54a). Ammonia will pass the membrane of the membrane stripping unit (43) resulting in an aqueous ammonium salt product (50). This aqueous ammonium salt product is discharged from the membrane stripping unit via an outlet (55). The aqueous remaining fraction (56) poor in total ammonia nitrogen (TAN) is recycled back to the electrodialysis unit (41) where it picks up fresh ammonium bicarbonate and potassium to become the concentrate (47). A purge (57) is present downstream the ammonium membrane stripping unit (43) and upstream the electrodialysis unit (41) to avoid build up of non-separated compounds. Carbon dioxide (58) is separated from the bicarbonate acid fraction (51) in degassing unit (59). The remaining aqueous fraction (60) is recycled to the bipolar membrane electrodialysis unit (42). A purge (57a) is present downstream degassing unit (59) to avoid build up of non-separated compounds, such as acids.

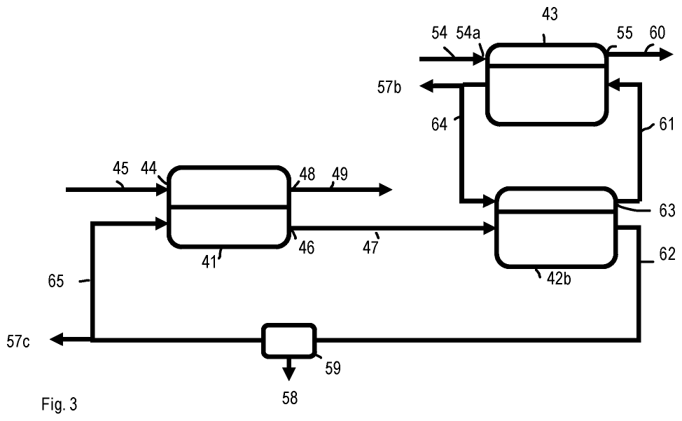

FIG. 3 shows a process scheme consisting of an electrodialysis unit (41), a bipolar membrane electrodialysis unit (42) and a membrane stripping unit (43) as in FIG. 2. The difference is that the bipolar membrane electrodialysis unit (42b) of FIG. 3 is a unit of the two chamber type wherein each cell pair comprises a bipolar membrane (BPM) and an cation exchange membrane (CEM). In such a unit (42b) ammonium and potassium cations will predominantly pass the cation exchange membranes (CEM) to become the total ammonia nitrogen (TAN) alkaline fraction (61). The bicarbonate ions as present in the concentrate (47) thus do not pass a membrane and will remain in the aqueous fraction to become bicarbonate acid fraction (62). An outlet (63) for the total ammonia nitrogen (TAN) alkaline fraction (61) is fluidly connected to the membrane stripping unit (43). To membrane stripping unit (43) an aqueous acid feed (54) is fed. Ammonia will pass the membrane of the membrane stripping unit (43) resulting in an aqueous ammonium salt product (50). This aqueous ammonium salt product is discharged from the membrane stripping unit via an outlet (55). The aqueous remaining fraction (64) poor in total ammonia nitrogen (TAN) is recycled back to the bipolar membrane electrodialysis unit (42) where it picks up fresh ammonium bicarbonate and potassium to become the total ammonia nitrogen (TAN) alkaline fraction (61). Carbon dioxide (58) is separated from the bicarbonate acid fraction (62) in degassing unit (59). The remaining aqueous fraction (65) is recycled to the electrodialysis unit (41). A purge (57b) is present downstream the membrane stripping unit (43) to avoid build up of non-separated compounds, such as potassium ions. A purge (57c) is present downstream degassing unit (59) and upstream the electrodialysis unit (41) to avoid build up of non-separated compounds, such as acids.

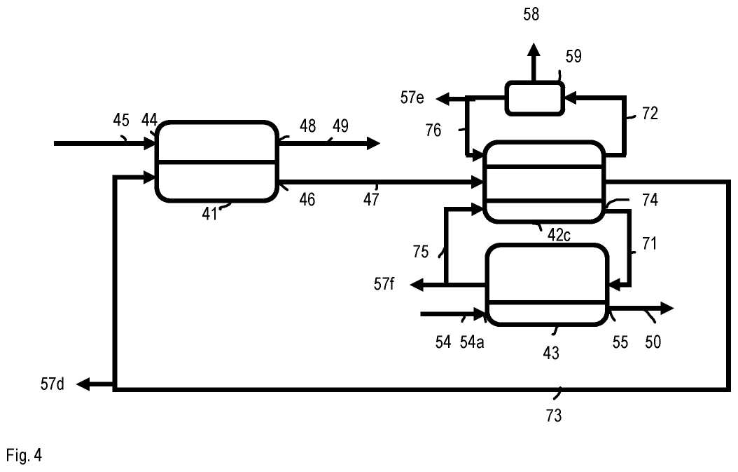

FIG. 4 shows a process scheme for an exemplary aqueous feed comprising of solids, ammonium bicarbonate, phosphate ions, magnesium cations and calcium cations as obtained from a sludge dewatering process as part of a wastewater treatment plant. The process scheme consisting of an electrodialysis unit (41), a bipolar membrane electrodialysis unit (42) and a membrane stripping unit (43) as in FIG. 2. The difference is that the bipolar membrane electrodialysis unit (42c) of FIG. 4 is a unit of the three chamber type wherein each cell pair comprises a bipolar membrane (BPM), an anion exchange membrane (AEM) and a cation exchange membrane (CEM). In such a unit (42c) ammonium and potassium cations will predominantly pass the cation exchange membranes (CEM) to become the total ammonia nitrogen (TAN) alkaline fraction (71), bicarbonate ions will predominantly pass the anion exchange membranes (AEM) to become a bicarbonate acid fraction (72). The starting concentrate (47) will the become a third remaining aqueous fraction (73) poorer in total ammonia nitrogen (TAN) and bicarbonate ions. An outlet (74) for the total ammonia nitrogen (TAN) alkaline fraction (71) is fluidly connected to the membrane stripping unit (43). To membrane stripping unit (43) an aqueous acid feed (54) is fed. Ammonia will pass the membrane of the membrane stripping unit (43) resulting in an aqueous ammonium salt product (50). This aqueous ammonium salt product is discharged from the membrane stripping unit via an outlet (55). The aqueous remaining fraction (75) poor in total ammonia nitrogen (TAN) is recycled back to the bipolar membrane electrodialysis unit (42c) where it picks up fresh ammonium bicarbonate and potassium to become the total ammonia nitrogen (TAN) alkaline fraction (71). Carbon dioxide (58) is separated from the bicarbonate acid fraction (72) in degassing unit (59). The third remaining aqueous fraction (76) is recycled to the electrodialysis unit (41). A purge (57d) is present to avoid build up of non-separated compounds. A purge (57d) is present to avoid build up of non-separated compounds in the third remaining aqueous fraction (73). A purge (57e) is present downstream degassing unit (59) to avoid build up of non-separated compounds, such as acids. A purge (57f) is present downstream the membrane stripping unit (43) to avoid build up of non-separated compounds, such as potassium ions.

The invention will be illustrated by the following non-limiting examples.

### EXAMPLE 1

Raw cow manure was separated using a screw press into a first wet solids fraction and an aqueous fraction rich in total ammonia nitrogen (TAN) and solid particles. This aqueous solution was filtered using a series of bag filters with the smallest pore size being 5 micron to obtain the second aqueous fraction. The TAN concentration of the second aqueous fraction was 2.57 g/L.

The experimental BPMED set-up was a bench-scale PC-Cell 64004 ED cell, consisting of a Pt/Ir-MMO coated and Ti-stretched metal anode and a stainless-steel cathode, both with a surface area of 8×8 cm2. The BPMED system was of the three-chamber type. The membranes and electrodes were separated by 0.5 mm thick wire mesh spacers with a void fraction of 59% made from silicon/polyethylene sulfone to form diluate, acid and base (flow) cells and electrode rinse compartments. The cell contained a BPMED membrane stack consisting of ten cell triplets as described in more detail in Bipolar membrane electrodialysis for energetically competitive ammonium removal and dissolved ammonia production, Niels van Linden, Giacomo L. Bandinu, David A. Vermaas, Henri Spanjers, Jules B. van Lier, Journal of Cleaner Production, Elsevier, 20 Jun. 2020.

The voltage between anode and cathode was held at 20 V constant. The separation was performed as a batch process wherein the aqueous fraction is recycled over the BPMED stack and wherein in time this fraction becomes a solid particle comprising aqueous fraction poor in total ammonia nitrogen (TAN) and poor in bicarbonate. The acid and alkaline fractions as present between respectively the AEM and BPM and BPM and CEM membranes are also recycled to obtain in time the bicarbonate acid fraction and the alkaline fraction rich in total ammonia nitrogen (TAN).

After 134 minutes the three streams were analysed. The pH of the obtained aqueous bicarbonate acidic fraction was 1.59. The pH of the aqueous alkaline fraction was 12.55. The content of NH₃ in the aqueous alkaline fraction was 1.0 g/L. The TAN concentration in the third remaining fraction was 1.35 g/L . 47% of the TAN was thus removed from the feed of the BPMED. Energy required to remove one kg of N was 63 MJ/kg. An even more improved separation may be achieved using BPMED membrane stacks consisting of more cell triplets. Almost all of the phosphate ions remained in the third remaining fraction. The majority of potassium ions were found in the alkaline fraction.

### EXAMPLE 2

Example 1 was repeated except that the starting manure was a suspension obtained after co-digesting pig manure. The TAN concentration of the second aqueous fraction was 4.67 g/L. After 98 minutes the three streams were analysed. The pH of the obtained aqueous bicarbonate acidic fraction was 2.14. The pH of the aqueous alkaline fraction was 12.64. The content of NH₃ in the aqueous alkaline fraction was 4.41 g/L. The TAN concentration in the third remaining fraction was 1.04 g/L. 79% of the TAN was thus removed from the feed. Energy required to remove one kg of N was 26 MJ/kg. An even more improved separation may be achieved using BPMED membrane stacks consisting of more cell triplets. Almost all of the phosphate ions remained in the third remaining fraction. The majority of potassium ions were found in the alkaline fraction.

### EXAMPLE 3

In this example a three-compartment bipolar membrane electrodialysis (BPMED-3C) configuration was compared to a two-compartment bipolar membrane electrodialysis configuration with only cation exchange membranes (BPMED-2C-C) for an ammonium bicarbonate solution having a TAN concentration of 5 g/L. The three-compartment bipolar membrane electrodialysis (BPMED-3C) configuration had the same dimensions and membranes as described in Example 1. The two-compartment bipolar membrane electrodialysis configuration was as the three-compartment bipolar membrane electrodialysis (BPMED-3C) configuration except that the ion-exchange membranes were absent and only cation exchange membranes (BPMED-2C-C) were present.

The results showed that the BPMED-2C-C configuration had a lower energy consumption to achieve approximately 90% TAN removal compared to the energy consumption of the BPMED-3C configuration achieving 90% TAN removal. The energy consumption for the BPMED-2C-C was 3.5 MJ per kilogram nitrogen removed and for the BPMED-3C 4.9 MJ per kilogram nitrogen removed. Furthermore, the use of a BPMED-2C-C allowed for more efficient recovery of TAN as NH₃ in the alkaline fraction, compared to the BPMED-3C configuration. For the BPMED-2C-C configuration, at 66% TAN removal, 77% of the TAN was present as NH₃ in the alkaline fraction, while for the BPMED-3C configuration, at 72% TAN removal, only 50% of the TAN was present as NH₃ in the alkaline fraction and more NH3 was present in the bicarbonate acidic fraction. The higher NH₃ content further allowed for a more efficient separation of ammonia from the alkaline fraction.

### EXAMPLE 4

The experimental ED-BPMED-VMS set-up consisted of two bench-scale PC-Cell 64004 cells placed in series, followed up by a VMS module. In the first cell an ED stack of 10 cell pairs was present and in the second cell a BPMED stack of 4 triplets (3 chamber) was present. Both cells had an electrode surface area of 8×8 cm2.

Co-digested pig manure was first filtered using bag filters to obtain an aqueous feed comprising particles having a size of smaller than 20 micron. This solution was used as feed to the first cell. The initial TAN concentration of the aqueous feed was 6.6 g/L. The duration of the experiment was similar to Example 2. The TAN concentration in the feed was lowered to 1.58 g/L (concentration of resulting diluate). 80% of the TAN was thus removed from the aqueous feed. The concentrate was subsequently separated into an alkaline and bicarbonate fraction in the BPMED cell where a 100% recovery of TAN was achieved.

### EXAMPLE 5

Example 4 was repeated except that only a BPMED cell was present. No ED stack was present. In order to achieve the same 80% removal of TAN a BPMED cell stack was required having a 40% higher bipolar membrane area.

### EXAMPLE 6A

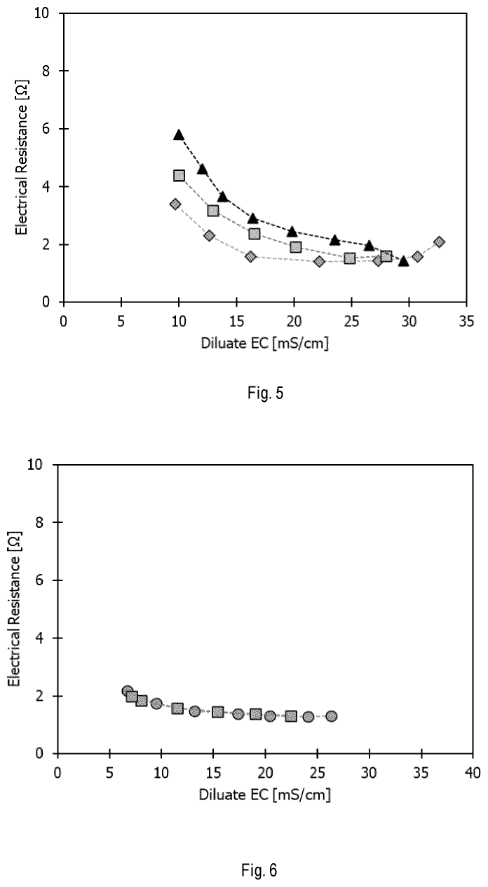

In an ED installation having a membrane stack of thirty cell pairs with a 1,000 cm2 electrode area 30 liter of a liquid fraction of raw pig manure was separated into a diluate and a concentrate. The liquid fraction contained 4 g/L of TAN concentration and contained particles having a size of less than 20 micron. The ED installation was operated to consistently achieve a removal of TAN of higher than 75%. The resistance of the membrane stack was measured during the treatment of the first batch of 30 L. The results are presented in FIG. 5 as the diamonds. Without cleaning the membrane stack a second batch of 30 liters of the liquid fraction of raw pig manure was separated into a diluate and a concentrate such to achieve a 75% removal of TAN. The resistance of the membrane stack was measured again during the treatment of the second batch of 30 L. The results are presented in FIG. 5 as the squares. Without cleaning the membrane stack a third batch of 30 liters of the liquid fraction of raw pig manure was separated into a diluate and a concentrate such to achieve a 75% removal of TAN. Again, during the treatment of the third batch of 30 L, the resistance of the membrane stack was measured. The results are presented in FIG. 5 as the triangles. It is observed that the resistance increases after every batch indicating membrane fouling.

### EXAMPLE 6B

The resistance of the membrane stack was measured as described in Example 6a. After the three treated batches in Example 6a, the polarity of the electrodes was reversed, as well as the flow directions of the diluate and concentrate solutions. The measured resistance is shown in FIG. 6. In FIG. 6 the circles are the measurements of the membrane resistance before performing the experiment at the reversed polarity and the squares are the measurements of the membrane resistance after performing the experiment and the application of polarity reversal. This shows that by applying this so called electrode polarity reversal option, also referred to as electrodialysis reversal (EDR), fouled membranes can be restored.

### EXAMPLE 6C

Without cleaning the membrane stack of Example 6b a batch of 30 liters of the liquid fraction of raw pig manure was separated into a diluate and a concentrate according to Example 6a. The resistance of the membrane stack was measured during the treatment. Subsequently, the EDR function was applied and another batch of 30 liters of the liquid fraction of raw pig manure was separated into a diluate and concentrate according to Example 6a. By applying the EDR function between the treatment of two consecutive batches, about the same resistance was measured during the second batch as compared to the resistance measured during the first batch indicating that no or very little fouling occurred.

### EXAMPLE 7

An aqueous NH₃ solution having a 10 g/L TAN concentration was continuously recirculated over a hydrophobic membrane within a membrane housing of a vacuum membrane separator (VMS) module as described in Niels van Linden, Henri Spanjer, Jules B. van Lier, Fuelling a solid oxide fuel cell with ammonia recovered from water by vacuum membrane stripping, Chemical Engineering Journal, Volume 428, 15 Jan. 2022, 131081.A vacuum was applied by a vacuum pump on the permeate side of the hydrophobic membrane, which allowed for NH₃ gas and water vapor to be transported to the permeate side. After passing the vacuum pump the obtained gaseous mixture was condensed in a cool trap to obtain a condensed NH₃ aqueous solution having a TAN concentration of 34 g/L . Thus a concentration factor of 3.4 was obtained. In a next experiment water was condensed before the vacuum pump in a cool trap at the vacuum pressure conditions. The thus condensed water was separated from the remaining gas. The remaining gas was subsequently condensed at atmospheric pressure after the vacuum pump as above to obtain an aqueous solution having a TAN concentration of 58.4 g/L. Thus a concentration factor of 5.8 was obtained.

1. A process for separating an aqueous feed comprising of dissolved ammonium bicarbonate by
(a) performing an electrodialysis in an electrodialysis unit wherein ions are transported via a membrane from the aqueous feed under influence of a positive and negative electrode to a mineral poor aqueous solution to obtain a concentrate comprising of ammonium bicarbonate and wherein the remaining aqueous feed is obtained as a diluate, wherein the electrodialysis unit does not comprise a bipolar membrane,
(b) separating the total ammonia nitrogen (TAN) as present in the concentrate from the bicarbonate ions as present in the concentrate by means of a bipolar membrane electrodialysis as performed in a bipolar membrane electrodialysis system to a total ammonia nitrogen (TAN) alkaline fraction and a bicarbonate acid fraction,
wherein in step (b) the bipolar membrane electrodialysis system is of a three chamber type with bipolar membranes (BPM), an anion exchange membranes (AEM) and a cation exchange membranes (CEM), wherein the bicarbonate ions pass the anion exchange membrane to become the bicarbonate acid fraction, wherein the ammonium ions of the total ammonia nitrogen (TAN) pass the cation exchange membrane to become the total ammonia nitrogen (TAN) alkaline fraction and wherein the remaining concentrate is obtained as a third remaining aqueous fraction, which third remaining aqueous fraction is recycled to the electrodialysis of step (a) to be used as the mineral poor aqueous solution where it picks up the ammonium bicarbonate to become the concentrate or
wherein in step (b) the bipolar membrane electrodialysis system is of a two chamber type with bipolar membranes (BPM) and cation exchange membranes (CEM), wherein the ammonium ions of the total ammonia nitrogen (TAN) pass the cation exchange membrane to become the total ammonia nitrogen (TAN) alkaline fraction and wherein the remaining concentrate becomes the bicarbonate acid fraction,
wherein part of the bicarbonate in the bicarbonate acid fraction is separated as carbon dioxide to obtain an aqueous fraction poor in bicarbonate which aqueous fraction poor in bicarbonate is recycled to the electrodialysis of step (a) to be used as the mineral poor aqueous solution where it picks up the ammonium bicarbonate to become the concentrate.

2. The process according to claim 1, wherein the electrodialysis is performed by applying a polarity between two electrodes and
wherein periodically the polarity of the electrodes is reversed.

3. The process according to claim 1, wherein the bipolar membrane electrodialysis system is of the three chamber type and wherein the bipolar membrane electrodialysis of step (b) is performed in a stack of between 1 and 200 cell triplets present between an anode and a cathode,
wherein each cell triplet comprises the bipolar membrane (BPM), the anion exchange membrane (AEM) and the cation exchange membrane (CEM) and
wherein a spacer is present between the anion exchange membrane (AEM) and the cation exchange membrane (CEM) such that the distance between the anion exchange membrane (AEM) and the cation exchange membrane (CEM) is between 0.1 and 10 mm.

4. The process according to claim 1, wherein the bipolar membrane electrodialysis system is of the two chamber type and wherein the bipolar membrane electrodialysis of step (b) is performed in a stack of between 1 and 200 cell pairs present between an anode and a cathode, wherein each cell pair comprises the bipolar membrane (BPM) and the cation exchange membrane (CEM) and wherein the distance between bipolar membrane (BPM) and the cation exchange membrane (CEM) is between 0.1 and 10 mm.

5. The process according to claim 1, wherein the aqueous feed comprises solids and preferably between 0.1 and 5 wt % solids and wherein substantially all of the solids of the feed end up in the diluate.

6. The process according to claim 5, wherein more than 95 wt % of the solids in the aqueous feed have a dynamic diameter of less than 50 μm, preferably less than 5 μm.

7. The process according to claim 1, wherein the aqueous feed comprises bivalent and/or trivalent ions and/or cations.

8. The process according to claim 7, wherein the aqueous feed comprises phosphate, magnesium, calcium, potassium and bicarbonate ions and total ammonia nitrogen (TAN) and
wherein in the electrodialysis step (a) the majority of the phosphate, magnesium and calcium ions remain in the diluate and
wherein the majority of the total ammonia and bicarbonate ions and potassium ions end up in the concentrate.

9. The process according to claim 1, wherein in a next step (c) ammonia is separated from the total ammonia nitrogen (TAN) alkaline fraction by means of a membrane stripping process using an acidic aqueous solution as a stripping medium thereby obtaining an aqueous solution of ammonium salt.

10. The process according to claim 9, wherein the acidic aqueous solution is a sulfuric acid aqueous solution or a nitric acid aqueous solution.

11. The process according to claim 8, wherein the aqueous feed is the liquid fraction of manure or a waste water fraction.

12. (canceled)

13. The process according to claim 8, wherein the waste water is obtained in an anaerobic treating process of municipal or industrial wastewater and/or the aqueous feed is reject water obtained in a sludge dewatering process as part of a wastewater treatment plant.

14. (canceled)

15. A process to separate manure comprising of an aqueous suspension of solid particles comprising of organic bound nitrogen and total ammonia nitrogen (TAN) by performing the following steps
(i) separating the majority of the solids from the aqueous suspension such to obtain a first wet solids fraction rich in organic bound nitrogen and a first aqueous fraction rich in total ammonia nitrogen (TAN) and solid particles,
(ii) separating the majority of the solid particles from the first aqueous fraction to obtain a second aqueous fraction poor in solids and a second solids fraction, and
(iii) separating the second aqueous fraction comprising of dissolved ammonium bicarbonate by the process according to claim 1.

16. The process according to claim 15, wherein the solid content of the first wet solids fraction obtained in step (i) is between 5 and 40 wt %.

17. The process according to claim 15, wherein at least 60% of the solids as present in the aqueous suspension is comprised in first wet solids fraction.

18. The process according to claim 15, wherein the manure has been subjected to an anaerobic digestion process before being treated in step (i).

19. The process according to claim 15, wherein the mass flows for nitrogen, phosphorus and potassium are measured in step (i) and in step (ii) and shared on line with a central monitoring organization for administrative and/or commercial purposes.

20. A process configuration comprising an electrodialysis unit, a bipolar membrane electrodialysis unit and a membrane stripping unit,
wherein the electrodialysis unit has an outlet for a concentrate which is fluidly connected to the bipolar membrane electrodialysis unit and wherein the electrodialysis unit does not comprise a bipolar membrane,
wherein the bipolar membrane electrodialysis unit is of a three chamber type with bipolar membranes (BPM), an anion exchange membranes (AEM) and a cation exchange membranes (CEM), or
wherein the bipolar membrane electrodialysis system is of a two chamber type with bipolar membranes (BPM) and cation exchange membranes (CEM), and
wherein the bipolar membrane electrodialysis unit has an outlet for a total ammonia nitrogen (TAN) alkaline fraction.

21. The process configuration according to claim 20, wherein the electrodialysis unit is an electrodialysis reversal (EDR) unit.

22. The process configuration according claim 20, wherein the outlet for a total ammonia nitrogen (TAN) alkaline fraction is fluidly connected to the membrane stripping unit and wherein the membrane stripping unit has an inlet for an aqueous acid feed and an outlet for an aqueous ammonium salt product.

23. A manure recycle process configuration comprising of a first separator in which a manure comprising of an aqueous suspension of solid particles comprising of organic bound nitrogen and total ammonia nitrogen (TAN) is separated into a first wet solids fraction rich in organic bound nitrogen as a first fertiliser and a first aqueous fraction rich in total ammonia nitrogen (TAN) and solid particles,
a second separator suited to separate the majority of the solid particles from the first aqueous fraction by means of filtration to obtain a second aqueous fraction poor in solids and a second solids fraction as a second fertiliser, and a process configuration according to claim 20.

24. (canceled)
